(19) United States
(12) Patent Application Publication
(10) Pub. No.: US 2026/0111827 A1
(43) Pub. Date: Apr. 23, 2026

(54) System and method for quantifying employee workplace performance and assessing work culture through emotional and mood analytics

(71) Applicant: Imran Aman, Doha (QA)

(72) Inventor: Imran Aman, Doha (QA)

(21) Appl. No.: 18/918,136

(22) Filed: Oct. 17, 2024

(51) Int. Cl. G06Q 10/0639

(52) U.S. Cl. CPC G06Q 10/06398

(57) ABSTRACT

A system and method for assessing employee workplace performance and work culture A system and method for assessing employee workplace performance and work culture through emotional and mood analytics are disclosed. The application number for this invention is Ser. No. 18/918,136 filed on Oct. 17, 2024. The system features a User Portal for employees to input their current mood, the reason for their mood, and a performance score. This data is processed by a quantifier module to generate a performance score (PS). An Administrator Portal then receives and analyzes this data using a Data Analytics module. By correlating individual employee mood data with performance metrics, the system provides unique insights into the emotional well-being and productivity of a workforce. This innovative approach offers a comprehensive assessment of work culture, allowing for more informed decisions on how to improve overall performance and employee satisfaction.

### FIELD OF INVENTION

Embodiments of the present disclosure generally relate to a workforce analytics system. More precisely, the present disclosure presents an algorithm to quantify employee work performances based on his emotions, mood and motivation.

### BACKGROUND

The emotions, mood of an individual significantly influences their work performance, as it directly impacts their motivation, concentration, and overall productivity. When people are in a positive state of mind, they are more likely to tackle tasks with increased enthusiasm and creativity. This positive outlook can enhance their problem-solving skills and foster better collaboration with colleagues. Emotions such as joy and satisfaction often lead to higher levels of engagement, making employees more resilient in the face of challenges and more likely to produce high-quality work. This uplift in morale not only boosts individual performance but also contributes to a more cohesive and efficient team environment.

Businesses have always sought methods of rating employee performance which reflect the true impact on the organization's progress. Early methods of quantizing human performance generally relied on subjective observations of the employee's emotions, mood and its impact on his performance. The 20th century gave rise to studies like the Hawthorne experiments where scientific proof of linkage between employee emotions and productivity was established, though emotions, mood was largely measured qualitatively. More specifically what the Hawthorne series of experiments produced was an improvement in employee performance as a result of “interest” shown in them, linking towards an increased motivation and thus better performance, not incorporating the emotions with corporate productivity. Standardized scales like the Likert scales and emotions, mood questionnaires were introduced towards the end of the 20^{th}/start of the 21^{st} century, allowing for a more structured assessment. With the advancement of technology, the late 20^{th} century also saw the introduction of quantitative tools like the positive and negative affect schedule (PANAS) as well as sentiment analysis (used commonly in clinical studies), enabling more precise emotions, mood-performance correlation to an individual's performance. The present-day advancements in artificial intelligence (AI) and machine learning (ML) have played a significant role in real-time emotions, mood tracking/prediction, using big data and predictive analytics to refine the general understanding of how emotions impact workplace performance. Software applications/portals that leverage AI and machine learning to assess employee emotions, moods are highly valued for quantifying performance, ultimately contributing to the development of a more equitable employee reward system for the overall organization.

Current algorithms for quantifying human performance can broadly be classified into three categories depending on how the user data is collected: (a) Systems relying on physical data, (b) systems relying on expression analysis, (c) system relying on biological markers, and (d) systems utilizing user behavior and habits. The first category uses actual sensors placed on user's body to measure physical parameters (blood pressure, heart rate etc.). These parameters are then used to determine the stress and anxiety levels, which are used to quantify the performance using mathematical relations. US20020135618, CN206239427, US20180341868 and WO2023224349 are examples of disclosed technologies relying on physically measured data to determine the performance score. The second category utilizes facial imagery of individuals to determine their emotions, mood; U.S. Pat. No. 10,061,977B1, CN108563978 and CN116434955 use live facial images along with AI/ML techniques to determine the instantaneous emotions, mood of a user to quantify their performance. A limited number of prior-art like US20200024663 utilizes biomarkers found with a human DNA to determine the emotions, mood, and form the third category of human performance quantifying algorithms. By using the fact that certain emotions, moods increase/decrease the presence of a select biomarkers within a human's genetic system, the emotions, mood can be estimated accurately using DNA. The fourth and final type of quantification involves monitoring the activities of an individual (online or offline) and determining patterns which may relate to certain mental conditions depicting emotions, mood.

A review of the aforementioned prior-art clearly points out multiple shortcomings. Physically rigging sensors onto subjects has shown to increase anxiety, image processing methodologies have stringent requirements for high-end processing equipment, genetic analysis systems require intrusion which many users may not allow, and activity monitoring setups demand access to a person's private life (online or otherwise) raising privacy concerns. In view of these and other limitations observed in the prior-art, there remains a growing need to provide a quick, unintrusive and fairly accurate method of quantizing work performance. The disclosed algorithm provides a solution to the identified problems in the prior-art while linking human emotions to corporate productivity, not provided by any of the existing methodologies, enabling employers to actively monitor staff performance regularly.

### SUMMARY OF THE PRESENT DISCLOSURE

The following presents a simplified summary of features disclosed herein to provide a basic understanding of some exemplary embodiments of the present disclosure. This summary is neither an exclusive overview of all the different embodiments of the present disclosure, nor intended to identify the critical elements of the disclosure. Its sole purpose is to present some concepts disclosed herein in a simplified form as a precursor to a more comprehensive description.

The present disclosure provides a system and a process to quantify the performance of an employee working at a certain task or for a defined time period. The system requires a self-assessment survey to be filled by the employee, which is then used to quantify the employee's performance on a numerical scale based on emotion and mood data.

According to an embodiment of the present disclosure, the performance quantization system may comprise of a user portal and an administrator portal. The user portal may be configured to accept input from the authorized users on pre-defined items. According to the same embodiment, the administrator portal may provide a general overview of the overall performance scores (PS) of all individuals, performance score of different teams, a view of the historical progress of PS, and the general management of the employee's/team's emotional well being. According to the same embodiment, the administrator portal may also enable the authorized administrators to analyze performances, generate multiple graphical data representations, and enable data forwarding/alerting to designated users/management officials.

According to another embodiment of the present disclosure, the performance quantization system may comprise of a means to acquire input from the user, which may include, for example, the present emotions, mood of the user, through the respective user portal. According to the same embodiment, the performance quantization system may also require the user to select the reason behind the selected emotions, mood.

According to another embodiment of the present disclosure, the performance quantization system may also require the user to provide his/her individual percentage best effort as estimated by him/her.

According to yet another embodiment, the performance quantization system may use a mathematical formula to calculate a numerical PS from the input of emotions, mood and percentage best effort already entered by the user.

Advantages of the disclosed performance quantization system and method may include one or more of the following: the system enables the user to complete the survey between 20 to 45 seconds, does not require complicated sensors and equipment for data collection, is computationally simple and less time consuming, and helps record the user emotions, moods anonymously without any tracking of user identity.

The foregoing paragraphs have been provided by way of general introduction and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

The above-mentioned and other features of this disclosure, and the manner of attaining them, will become more apparent by reference to the following description of embodiments taken in conjunction with the accompanying drawings, wherein:

FIG. 1 a block diagram depicting the entire proposed performance quantization system.

FIG. 2 shows a flowchart for the proposed method of performance quantization as disclosed.

Corresponding reference numerals indicate corresponding parts throughout the figures. The exemplifications set herein illustrate merely the embodiments of the disclosure and such exemplifications are not to be construed as limiting the scope of the present disclosure in any manner.

### DETAILED DESCRIPTION

Embodiments of the present disclosure will now be described more fully hereinafter with reference to the accompanying drawings, in which some, but not all embodiments of the disclosure are shown. The present disclosure will be better understood with reference to the definitions, examples and descriptions provided herein.

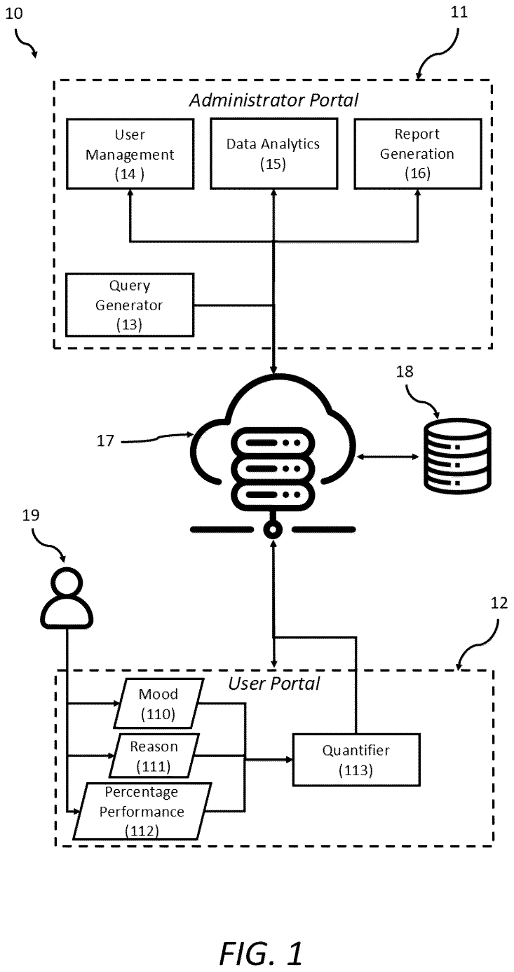

FIG. 1 shows a block level view 10 of the disclosed performance quantization system. The disclosed performance quantization consists of two main units namely, the administrator portal 11 and the user portal 12. The administrator portal 11 is manned by the organizational administrators which may be higher level management or a respective office with a higher level of privileges as compared to the user portal 12 and may be accessed via a computer software of a mobile application by using appropriate login credentials. More specifically, the administrator portal 11 offers the fundamental authority to generate queries for select users (or a group of users) to initiate the data gathering process from the corresponding user portals 12. The query generator 13 block of the administrator portal 11 enables the administrator to alert user portals 11 to gather data in order to generate a PS. The query generator 13 block may be configured to manually initiate data gathering requests from user portals 12 (or a group of user portals 12) at specific times, or via an already set data query schedule saved within the query generator 13. The administrator portal 11 further comprises of the user management 14, data analytics 15, and report generation 16 blocks allowing for management of new users, graphical depiction of the collected data/PS, and enabling of reporting of the collected data/calculated performance via different channels.

The administrator portal 11 as well as the user portal 12 are linked together through a network 17, which may for example be a local area network (LAN), Wi-Fi, or other inter-device connectivity methods. A database 18 may also be included a part of the system to save the user data, collected information and the calculated PS. The database 18 may be a network connected resource with either a dedicated hardware, or solely a cloud-based service fulfilling the storage requirements as deemed necessary.

The user portal 12 has two main functions; gathering data from the user 19 when triggered by the administrator portal 11, and to calculate and communicate the PS back to the administrator portal 11. Once queried, the user 19 logs in to their respective user portal 11 using the provided login credentials and enters the following three factors: his current emotions, mood 110, the reason behind his current emotions, mood 111, and his percentage performance 112 at that particular point of time. The emotions, mood 110 selection is made from a predefined group of emotions, moods as provided in Table 1, with corresponding weightages ranging from 1 (stressed) to 5 (motivated) already programmed into the system 10.

TABLE 1
Emotions, mood types and corresponding weightages pre-
set in the proposed performance quantization system.

| | Corresponding |
|---|---|
| | Emotions, mood |
| Emotions, moods | Weightages |
| Motivated | 5 |
| Excited | 4 |
| Content | 3 |
| Anxious | 2 |
| Disengaged | 1.5 |
| Stressed | 1 |

The user portal 12 also has a quantifier block 113 where the user inputs of current mood 110, reason behind the mood 111 and their percentage performance 112 are quantified into a numerical PS using the following mathematical relation:

$$Performance Score ( PS ) = ( \frac{Mood wieghtage}{5} ) \times ( \frac{P e r c e ntage performance}{100} ) \qquad ( 1 )$$

Once calculated the PS is stored in the database 18 connected through the network 17. The administrator portal 11 has continuous access to the individual user data collected from the user portals 12 as well as the corresponding PS. The administrator portal 11 may be used by the administrator to analyze the results, report the results and process the results in multiple ways.

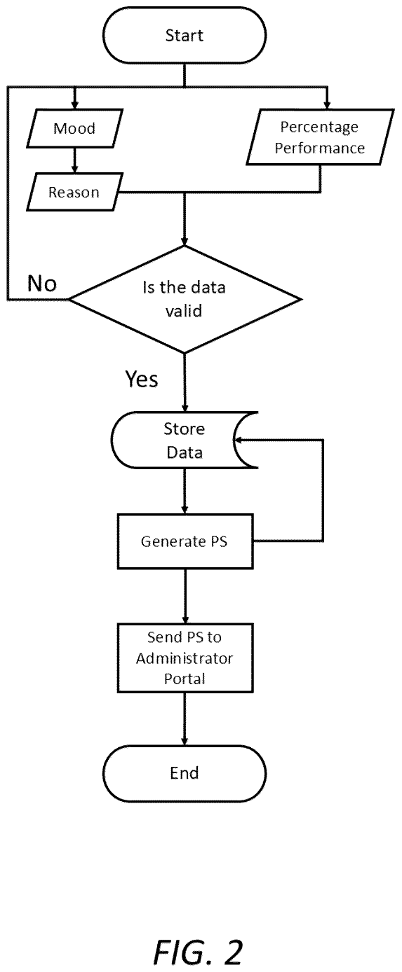

FIG. 2 shows a flowchart depicting the method of data collection and PS generation at the user portal 12. Once initiated, the data collection process starts with the user being prompted to select his current emotions, mood, the underlying reason behind his current emotions, mood, and enter his current percentage performance figure through the user portal 12. Once recorded and validated, the data is first stored in the network connected storage database 18 and then PS is calculated using the mathematical equation (1) as mentioned earlier, which is also store in the database 18. Once the PS is available, the administrator portal 11 is notified of process completion and the data can then be accessed by the administrator for necessary processing/visualization.

As is evident from the description, numerous adjustments and alterations can be made to the disclosed embodiments. It should be noted that the multiple embodiments of the present disclosure, disclosed herein, may be implemented differently from the specific description provided herein, as long as it falls within the boundaries defined by the following claims:

1. An employee performance quantization system comprising mainly of:
at least one administrator portal operating on a processor and configured to generate data collection queries and process the received data;
at least one user portal operating on a processor and configured to collect data from users and communicate it to the said at least one administrator portal; and
a storage medium configured to store user information and the collected data from the at least one user portal.

2. The employee performance quantization system according to claim 1, wherein the at least one administrator portal operating on a processor further comprises of:
a user interface to access the system;
a data query generation system having the ability to generate data collection requests to at least one user portals;
a report generation system;
a data analysis system;
a user management system allowing the creation of new users, deletion of existing users, and editing of existing user data; and
connectivity to the storage medium.

3. The employee performance quantization system according to claim 1, wherein the at least one user portal operating on a processor further comprises of:
a user interface to access the system;
a means of user data input;
collection and analysis of data from a user;
calculation of the performance score; and
connectivity to the storage medium.

4. The employee performance quantization system according to claim 1, wherein the storage medium is a network connected database.

5. The at least one user portal operating on a processor of claim 3, wherein the user interface is a display screen.

6. The at least one user portal operating on a processor of claim 3, wherein the means of user data input is a keyboard.

7. The at least one user portal operating on a processor of claim 3, wherein the means of user data input is a touchscreen.

8. The at least one user portal operating on a processor of claim 3, wherein the user interface is configured to receive input from an authorized user.

9. The at least one user portal operating on a processor of claim 3, wherein the data collected from the user includes emotions, mood weightage, reason behind the emotions, mood, and the percentage performance.

10. The at least one user portal operating on a processor of claim 3, wherein the performance score is calculated by using the mathematical relation:
$$Performance Score ( PS ) = ( \frac{Mood wieghtage}{5} ) \times ( \frac{P e r c e ntage performance}{100} ) .$$

11. The at least one administrator portal operating on a processor of claim 2, wherein the data analysis system provides on-demand graphical expressions of the user data retrieved from the storage medium.

12. The at least one administrator portal operating on a processor of claim 2, wherein the connectivity to the storage medium is through a data network.

13. The at least one user portal operating on a processor of claim 3, wherein the connectivity to the storage medium is through a data network.

14. The employee performance quantization system of claim 1, wherein
the at least one administrator portal operating on a processor has network connectivity; and
the at least one user portal operating on a processor has network connectivity.

15. A method for employee performance quantization, comprising the steps of:
generating a data query to the at least one user portal;
prompting the employee to input an emotional information factor which may include mood weightage, reason behind the emotions, mood and the percentage performance through their corresponding user portal;
calculating the performance score; and
storing the data and the performance score within the storage medium.

16. A method for employee performance quantization of claim 15, wherein the data query generation further comprises the steps of:
selecting a particular user portal from the list of all available user portals; and
generating a notification within the selected user portals for the user to enter data.

17. A method for employee performance quantization of claim 15, wherein the employee data entry comprises the steps of:
displaying all possible emotions, mood types and weightages;
recording the user's selected choice of emotions, mood type;
displaying all possible reasons behind the selected emotions, mood type;
recording the user's selected choice of possible reason behind his selected emotions, mood type; and
recording the user's percentage performance.

18. A method of employee performance quantization of claim 15, wherein the entire process is completed within 45 seconds of initiation.

19. An employee data entry method of claim 17, wherein the identity of the employee is kept anonymous.
